(19) United States
(12) Patent Application Publication
(10) Pub. No.: US 2006/0254831 A1
(43) Pub. Date: Nov. 16, 2006

(54) Power assist apparatus and movable body including the same

(75) Inventors: Hiroki Kamei, Osaka (JP); Naoto Tojyo, Ikoma City (JP)

Correspondence Address: NDQ&M WATCHSTONE LLP, 1300 EYE STREET, NW, 400 EAST TOWER, WASHINGTON, DC, 20005, US

(73) Assignee: Sanyo Electric Co., Ltd., Moriguchi City (JP)

(21) Appl. No.: 11/411,860

(22) Filed: Apr. 27, 2006

(30) Foreign Application Priority Data
Apr. 27, 2005 (JP) JP 2005-129042

(51) Int. Cl. B62D 11/02; B60S 9/00

(52) U.S. Cl. 180/6.5; 180/204

(57) ABSTRACT

A power assist apparatus with a plurality of operating modes, which causes an object of operation to operate in one of the operating modes depending on an operating force applied thereto. The plurality of areas being demarcated based on directions in which the applied operating force works, and being associated with the plurality of operating modes. A hysteresis area is set up between each two adjacent areas of the plurality of areas. While in a first operating mode in which the operating mode to be selected is included in the plurality of operating modes, the operating mode selector selects the first operating mode when the applied operating force thus detected belongs to a hysteresis area abutting on an area associated with the first operating mode.

### CROSS REFERENCE TO RELATED APPLICATIONS

This application is based upon and claims the benefit of priority from the prior Japanese Patent Application No. P2005-129042 filed on Apr. 27, 2005, the entire contents of which are incorporated herein by reference.

### BACKGROUND OF THE INVENTION

1. Field of the Invention

The present invention relates to a power assist apparatus for controlling operations of a movable body by applying a force to an operating handle or the like thereof, and to a movable body including the power assist apparatus.

2. Description of Related Art

Japanese Patent Laid-Open (Kokai) Publication No. 2002-2490 discloses a technology for moving a movable body by detecting a force applied by an operator to an operation unit and by thus generating a driving force depending on the applied operating force. In the case of this type of movable body, operating modes, such as a straight movement mode, a course change mode and a revolution mode, are capable of being switched by an operator's changing strength and a direction of an operating force to be applied to the operating handle. However, when an operating force is in a boundary range between a force for selecting a straight movement and a force for selecting a course change, the operating modes are frequently changed due to shaky application of the force to the operating handle. In other words, each time the force changes back and forth over the boundary range due to shaky application of the force, unintentional changes of the operating modes occur. Accordingly, output from the motor for generating a driving force is fluctuated.

In addition, through International Publication Pamphlet No. 04/071842, the applicant of this patent application has already filed a patent application for a power assist apparatus. This power assist apparatus outputs signals for controlling an operation of a movable body by selecting one operating mode out of a plurality of operating modes included in the movable body and the like depending on an operating force which is applied to an operation unit such as an operating handle.

### SUMMARY OF THE INVENTION

The present invention provides a power assist apparatus and a movable body including the same capable of inhibiting the operating modes from being switched unintentionally due to shaky application of the force.

An aspect of the present invention provides a power assist apparatus with a plurality of operating modes, which causes an object of operation to operate in one of the operating modes depending on an operating force applied thereto, the power assist apparatus including, an operation unit to which the operating force is applied, an applied operating force detector configured to detect an applied operating force applied to the operation unit, an operating mode selector configured to determine to what area out of a plurality of areas the applied operating force detected belongs, and to select an operating mode associated with the area determined, the plurality of areas being demarcated based on directions in which the applied operating force works, and being associated with the plurality of operating modes, and an operation control signal outputting unit configured to output an operation control signal for controlling an operation of the object of operation depending on the operating mode thus selected, wherein a hysteresis area is set up between each two adjacent areas of the plurality of areas, and wherein, while in a first operating mode in which the operating mode to be selected is included in the plurality of operating modes, the operating mode selector selects the first operating mode when the applied operating force thus detected belongs to a hysteresis area abutting on an area associated with the first operating mode.

Even when an operator tries to keep the operating mode at a first operating mode, there are cases where the applied operating force may be slightly off an area associated with the first operating mode, such as by shaky application of the operating force. In the case of the present invention, however, while a selected operating mode is the first operating mode, the applied operating force belonging to a hysteresis area abutting on the area associated with the first operating mode is treated as (an applied operating force) belonging to the area associated with the first operating mode. Accordingly, in this case, the first operating mode is kept selected. This inhibits the operating modes from being switched unintentionally.

The plurality of areas are demarcated based on strengths of forces and on directions in which the forces work.

The operating mode selector determines to what area the applied operating force belongs based on a strength of the applied operating force thus detected, and on a direction in which the applied operating force thus detected works.

while the first operating mode is being selected, in a case where, based on the applied operating force, it is consecutively detected for a predetermined period of time that the applied operating force belongs to an area associated with a second operating mode different from the first operating mode, the operating mode selector selects the second operating mode.

When the operating mode selected by the operating mode selector is switched to another operating mode, the operation control signal outputting unit outputs an operation control signal needed for the switching of the operation modes while imposing an upper limit on a rate of change per unit time of strength of a driving force for causing the object of operation to operate.

As mentioned above, limiting on a rate of strength of a driving force or direction for causing the object of operation to operate enables the operating modes to be switched smoothly without causing the operator to feel the sense of incompatibility.

### BRIEF DESCRIPTION OF THE DRAWINGS

FIG. 1 is a perspective view of a carriage 1 using a power assist apparatus according to an embodiment of the present invention.

FIG. 2 is a diagram of the carriage 1 which is viewed from above.

FIG. 3 is a plan view showing a scheme of the power assist apparatus 2.

FIG. 4 is a block diagram showing outline of control of the power assist apparatus 2.

FIG. 5 is a vector diagram showing relationship between applied operating force works and the operating mode.

FIG. 6 is a vector diagram showing relationship between applied operating force works and the operating mode with hysteresis areas.

FIG. 7 is a vector diagram showing relationship between applied operating force works and the operating mode with hysteresis areas.

FIG. 8 is a vector diagram showing the first quadrant in which the driving force vector appears.

FIGS. 9A, 9B and 9C are plan views of carriages and power assist apparatuses according to another embodiment.

### DETAILED DESCRIPTION OF EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

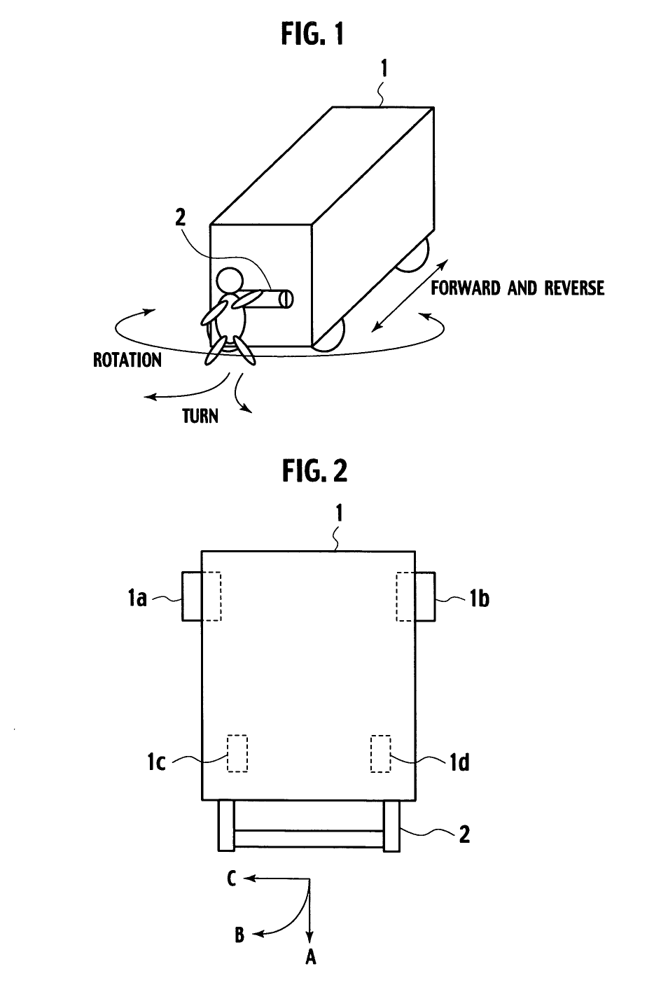

FIG. 1 is a perspective view of a carriage (a wheeled dolly) 1 using a power assist apparatus according to an embodiment of the present invention. FIG. 2 is a diagram of the carriage 1 which is viewed from above. The carriage 1 is also called an “electrically-driven cart” or an “electrically-driven carriage,” and is used for easily moving a load which is difficult to transfer.

As shown in FIG. 2, four wheels are attached to the carriage 1, which are, for example, a right rear wheel 1a, a left rear wheel 1b, a right front wheel 1c and a left front wheel 1d. In the case of the carriage 1 according to an embodiment of the present invention, driving wheels are only the right rear wheel 1a and the left rear wheel 1b. These driving wheels are fixed to the housing of the carriage 1. The right front wheel 1c and the left front wheel 1d are what are called “free casters,” and are pivotably attached to the housing of the carriage 1. The right front wheel 1c and the left front wheel 1d rotate in accordance with a direction in which the carriage 1 moves.

In addition, the carriage 1 is installed with a power assist apparatus 2. The carriage 1 has a configuration, in which an operator's application of an operating force, whenever necessary, to the power assist apparatus 2 enables the operation mode (operation condition) to be selected. Selectable operating modes include a straight movement mode, a course change mode and a revolution mode. In the straight movement mode, the carriage 1 is caused to move straight to the front. In the course change mode, a direction in which the carriage 1 moves is changed. In the revolution mode, the carriage 1 is revolved at one position about the center of the carriage 1. Adequate selection of one operating mode out of the three operating modes makes any necessary movement of the carriage 1 possible. Incidentally, it does not matter that the power assist apparatus is provided with subdivided operating modes.

In FIG. 2, an arrow A denotes a forward direction in which the carriage 1 moves straight while in the straight movement mode. In the straight movement mode, both the right rear wheel 1a and the left rear wheel 1b rotate at the same rotation speed (number of rotations per unit time) in a direction which causes the carriage 1 to move straight to the front. An arrow B denotes a direction in which the carriage 1 turns to the right while in the course change mode. In the course change mode, the right rear wheel 1a and the left rear wheel 1b rotate at the respective rotation speeds (the respective rotation directions if necessary) which differ depending on a radius in which the carriage 1 turns. An arrow C denotes a direction in which the carriage 1 revolves to the right while in the revolution mode. In the revolution mode, the right rear wheel 1a and the left rear wheel 1b rotate at the same rotation speed, but respectively in opposite directions. Only the control of rotations of the right rear wheel 1a and the left rear wheel 1b about the respective axes in this manner makes it possible to switch operating modes of the carriage 1. Selection of an operating mode is made on the basis of the operating force applied to the power assist apparatus (an applied operating force)

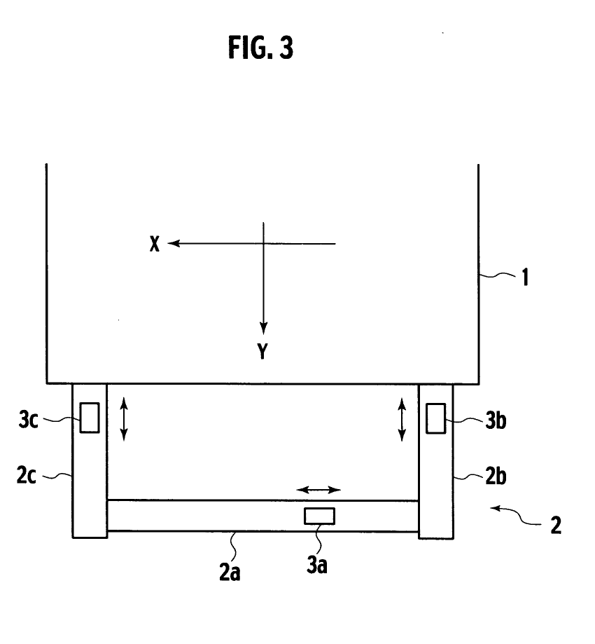

FIG. 3 is a plan view showing a scheme of the power assist apparatus 2. The power assist apparatus 2 includes an operating handle 2a, and operating-handle supporting parts 2b and 2c. The operating handle 2a is an operation unit. The operating-handle supporting parts 2b and 2c support the operating handle 2a at the two ends of the operating handle 2a, and are provided to the power assist apparatus 2 in a way that the operating-handle supporting parts 2b and 2c are substantially parallel to each other. An end of each of the operating-handle supporting parts 2b and 2c is connected to the operating handle 2a, and the other end of each of the operating-handle supporting parts 2b and 2c is fixed to the housing of the carriage 1. A pressure sensor 3a for detecting pressure applied to the operating handle 2a in the longitudinal direction is installed in the middle of the operating handle 2a. Pressure sensors 3b and 3c respectively for detecting pressure applied to the operating-handle supporting parts 2b and 2c in the longitudinal direction are installed in the middle of the operating handle supporting parts 2b and 2c respectively.

The longitudinal direction of the operating handle 2a is orthogonal to the longitudinal direction of each of the operating-handle supporting parts 2b and 2c. The longitudinal direction of each of the operating-handle supporting parts 2b and 2c is equal to the direction in which the carriage 1 moves while in the straight movement mode. The longitudinal direction of the operating handle 2a (the left-right direction in FIG. 3) is defined as the X-axis direction in the embodiment. The longitudinal direction of the operating-handle supporting parts 2b and 2c (the up-down direction in FIG. 3) is defined as the Y-axis direction in the embodiment. The X-axis component and the Y-axis component of an applied operating force are calculated on the basis of the detection results from the pressure sensors 3a, 3b and 3c. The installation of the two pressure sensors 3b and 3c as the pressure sensors for detecting pressure in the Y-axis direction makes it possible to additionally detect a rotation moment about the Z axis (not illustrated) orthogonal to both the X-axis and the Y-axis on the basis of the difference between pressure values respectively detected by the pressure sensors 3b and 3c.

Note that the two operating-handle supporting parts 2b and 2c may be substituted with a single operating-handle supporting part. The end of the single operating-handle supporting part is connected to the center of the operating handle, and the power assist apparatus 2 is shaped like the letter T. In this case, one pressure sensor for detecting pressure in the Y-axis direction can be installed in the single operating-handle part.

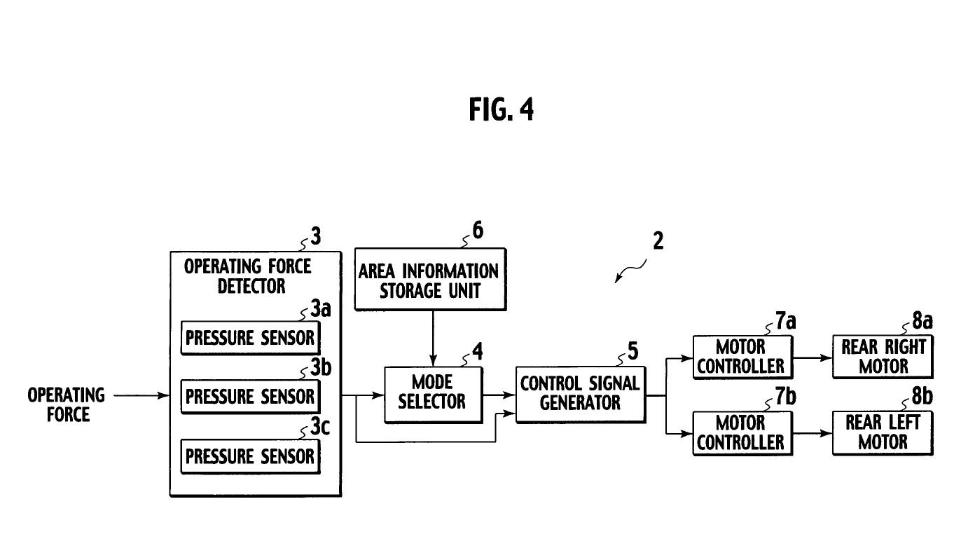

FIG. 4 is a block diagram showing an outline of control of the power assist apparatus 2. The pressure sensors 3a, 3b and 3c constitute an applied operating force detector 3, and sequentially detect an operating force applied to the operating handle 2a (an applied operating force) for each predetermined sampling period (for example, tens of Hertz). Detection signals corresponding to the detected operating force are transmitted to an operating mode selector 4 and an operation control signal outputting unit 5. On the basis of these detection signals, an operating force in the X-axis direction (an X-axis component of the applied operating force), an operating force in the Y-axis direction (a Y-axis component of the applied operating force) and the rotation moment about the Z axis are specified.

The operating mode selector 4 selects one operating mode on the basis of the sequential incoming detection signals while referring to determination area information stored in an area information storage unit 6. In other words, the operating mode selector 4 selects one operating mode from the straight movement mode, the course change mode and the revolution mode. The determination area information is information for specifying to what operating mode the applied operating force corresponds. Incidentally, it does not matter that the area information storage unit 6 is a memory included in the power assist apparatus 2, a portable (detachable) memory card or the like.

The operation control signal outputting unit 5 calculates rotation speeds at which, and rotation directions in which, the right rear wheel motor 8a and the left rear wheel motor 8b should rotate respectively, depending on the following parameters. The parameters are the selected operating mode and strength of the applied operating force which has been specified on the basis of the detection signals. Thus, the operating control signal outputting unit 5 outputs control signals (operation control signals) to motor controllers 7a and 7b, which are needed to actualize the radiation speeds and the rotation direction. The motor controllers 7a and 7b respectively supply the right rear wheel motor 8a and the left rear wheel motor 8b with predetermined amounts of driving current depending on these control signals.

The right rear wheel motor 8a and the left rear wheel motor 8b respectively drive the right rear wheel 1a and the left rear wheel 1b to rotate depending on the supplied amounts of driving current. In addition, the rotation speed and the rotation direction of the right rear wheel 1a are specified by those of the right rear wheel motor 8a. The rotation speed and the rotation direction of the left rear wheel 1b are specified by the rotation speed and the rotation direction of the left rear wheel motor 8b. As a result, the rotation speed and the rotation direction of each of the right rear wheel 1a and the left rear wheel 1b are controlled by the control signals (operation control signals) outputted by the operation control signal outputting unit 5. That is, an operation of the carriage 1 (a speed at which, and a direction in which, the carriage 1 moves) is controlled by the control signals (operation control signals) outputted by the operation control signal outputting unit 5.

When the carriage 1 is considered an object of operation, the motor controllers 7a and 7b, the right rear wheel motor 8a, the left rear wheel motor 8b, the right rear wheel 1a and the left rear wheel 1b constitute driving means which imparts a driving force to the object of operation depending on the control signals. Furthermore, when the right rear wheel 1a and the left rear wheel 1b are considered an object of operation, the motor controllers 7a and 7b, the right rear wheel motor 8a and the left rear wheel motor 8b constitute driving means which imparts a driving force to the object of operation depending on the control signals.

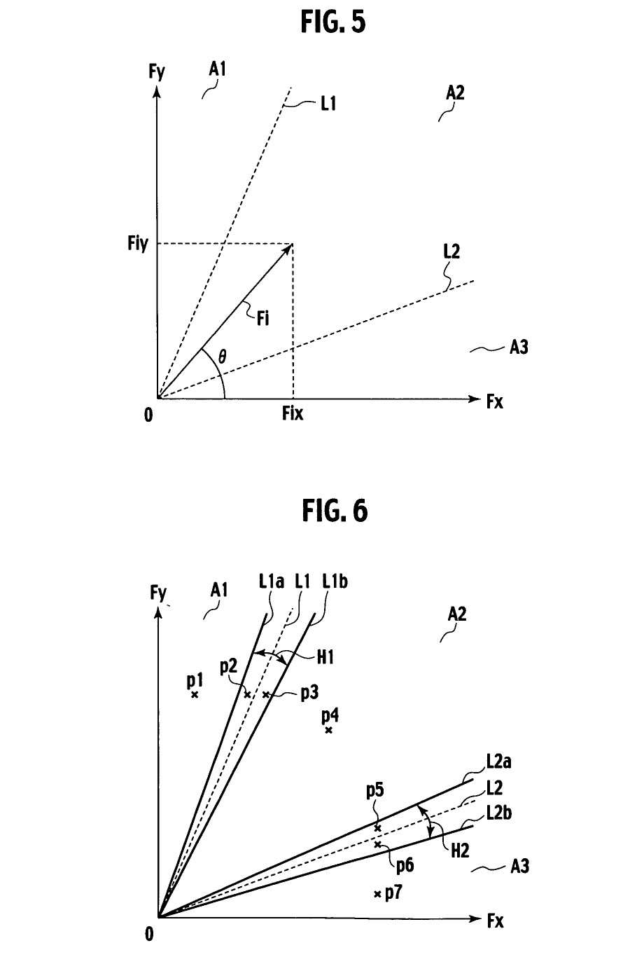

Hereinafter, descriptions will be provided for a method of specifying to what operating mode the applied operating force correspond. FIG. 5 is a vector diagram showing this specification. In a case where an operating force applied to the operating handle 2a is expressed with a vector, the vector (hereinafter referred to as an “applied operating force vector”) appears in any one of a first, second, third or fourth quadrants. For a simpler explanation, however, attention is paid only to the first quadrant. For example, attention is paid to a force which works as an operating force in the Y-axis direction so as to pull the carriage 1 towards the operating handle 2a. Concurrently, attention is paid to a force which works as an operating force in the X-axis direction so as to move the carriage 1 in a direction from the operating-handle supporting part 2b to the operating-handle supporting part 2c (see FIG. 3). When the applied operating force vector appears in any one of the second, third or fourth quadrants, movement of the carriage 1 is similar to the movement explained by descriptions below which focus on the first quadrant.

FIG. 5 shows only the aforementioned first quadrant. An axis of abscissa indicates the X-axis component of a force (Fx), and an axis of ordinate indicates the Y-axis component of a force (Fy). The first quadrant is divided into three areas corresponding respectively to the operating modes. For example, as shown in FIG. 5, an area A₁ and an area A₂ are separated by a demarcation line L₁, and an area A₂ and an area A₃ are separated by a demarcation line L₂. The divided areas (determination areas) A₁, A₂ and A₃ are associated respectively with the three operating modes in a one-to-one manner. Specifically, the area A₁ is associated with the straight movement mode. The area A₂ is associated with the course change mode (the right turn in this case). The area A₃ is associated with the revolution mode.

In FIG. 5, the applied operating force vector is expressed with Fi. In a case where an end point (end terminal) of the applied operating force vector Fi, whose initial point is the origin of ordinates, is present between the axis of ordinate (Fy axis) and the demarcation line L₁ (that is, in the area A₁), it is determined that, in principle, an area to which the applied operating force (the applied operating force vector) belongs is the area A₁. In a case where an end point of the vector Fi is present between the demarcation line L₁ and the demarcation line L₂ (that is, in the area A₂), it is determined that, in principle, an area to which the applied operating force (the applied operating force vector) belongs is the area A₂. In a case where an end point of the vector Fi is present between the demarcation line L₂ and the axis of abscissa (Fx axis) (that is, in the area A₃), it is determined that, in principle, an area to which the applied operating force (the applied operating force vector) belongs is the area A₃. (Descriptions will be provided for exceptional cases) FIG. 5 shows an example where the applied operating force vector Fi belongs to the area A₂. The X-axis component and the Y-axis component of the applied operating force vector Fi are expressed respectively with Fix and Fiy. In other words, the X-axis component and the Y-axis component of the operating force applied to the operating handle 2a as the operation unit are expressed respectively with Fix and Fiy. Descriptions will continue below with an assumption that initial points of all the applied operating force vectors are the origins of ordinates (where each of the X-axis component and the Y-axis component is equal to zero).

For example, both of the demarcation lines L1 and L2 are straight lines passing through the origin of ordinates, as shown in FIG. 5. In this case, it can be understood that the areas A₁, A₂ and A₃ are demarcated by only directions in which the applied operating force works. A direction in which the applied operating force works is defined as an azimuth θ (theta) between the axis of abscissa (Fx axis) and the applied operating force vector Fi.

An applied operating force having the applied operating force vector Fi, whose magnitude is smaller than a predetermined threshold value, is associated, for example, with the straight movement mode in which the running speed of the carriage 1 is equal to “zero.” It does not matter that the applied operating force in this case is associated with a stop mode other than the straight movement mode. In the case where the applied operating force is associated with the stop mode, the operating modes to be selected by the operating mode selector 4 are the following four modes: the straight movement mode, the course change mode, the revolution mode and the stop mode. An area corresponding to the stop mode is equivalent to the inside of a circle around the origin of ordinates with a radius represented by the threshold value.

Thus, a plurality of areas (for example, the areas A₁, A₂ and A₃) associated respectively with a plurality of operating modes are set up. These areas are demarcated by directions in which the applied operating force works, or by strengths of the applied operating force and the directions in which the applied operating force works. The strength of an applied operating force is equivalent to a magnitude of the applied operating force vector Fi, and is equal to the length |Fi| (that is, the square root of the sum of squares of Fix and Fiy) of the applied operating force vector Fi.

It should be noted that a method of demarcating the areas is not limited to the example shown in FIG. 5. It does not matter how areas are demarcated as long as the applied operating force vector Fi is associated with one of operating modes in a case where the end point of the applied operating force vector Fi, whose initial point is the origin of ordinates, appears in the first quadrant. How the first quadrant (in addition, the second to fourth quadrants) is divided depends on the determination area information which has been stored in the area information storage unit 6.

In this respect, descriptions will be provided for a method of switching operating modes according to this example. In this example, a hysteresis area is set up between each adjacent two of the areas. Accordingly, this makes it difficult for the operating modes to be unintentionally switched due to shaky application of the operating force or the like. FIG. 6 shows the first quadrant, where the applied operating force vector appears, and where hysteresis areas are also described. In the first quadrant shown in FIG. 6, the axis of abscissa indicates the X-axis component (Fx) of the force, and the axis of ordinate indicates the Y-axis component of the force, as in the case of the first quadrant shown in FIG. 5. In FIG. 6, the same reference numerals are used to designate the same items as those in FIG. 5, so that the overlapping description will be omitted.

As shown in FIG. 6, a demarcation line L1a is set up between the demarcation line L1 and the axis of ordinate (Fy axis), and a demarcation line L2b is set up between the demarcation line L2 and the axis of abscissa (Fx axis). In addition, two demarcation lines are set up between the demarcation lines L1 and L2. Out of the two demarcation lines, one demarcation line near the demarcation line L1 is called a demarcation line L1b, and the other demarcation line near the demarcation line L2 is called a demarcation line L2a. Furthermore, an area enclosed by the demarcation lines L1a and L1b is called a hysteresis area H1, and an area enclosed between the demarcation lines L2a and L2b is called a hysteresis area H2.

For example, all of the demarcation lines L1a, L1b, L2a and L2b are straight lines passing through the origin of ordinates (where both the X-axis component and the Y-axis component are equal to zero), as shown in FIG. 6. In addition, for example, the demarcation lines L1, L1a and L1b cross over one another at the origin of ordinates, as shown in FIG. 6. Furthermore, the crossing angle between the demarcation lines L1 and L1a is equal to the crossing angle between the demarcation lines L1 and L1b. Similarly, for example, the demarcation lines L2, L2a and L2b cross over one another at the origin of ordinates, and the crossing angle between the demarcation lines L2 and L2a is equal to the crossing angle between the demarcation lines L2 and L2b. Moreover, the crossing angle between the demarcation lines L1b and the axis of abscissa (Fx axis) is larger than the crossing angle between the demarcation line L2a and the axis of abscissa (Fy axis).

An area enclosed by the demarcation lines L1 and L1a is included in the area A1 and the hysteresis area H1 at the same time. An area enclosed by the demarcation lines L1 and L1b is included in the area A2 and the hysteresis area H1 at the same time. An area enclosed by the demarcation lines L2 and L2a is included in the area A2 and the hysteresis area H2 at the same time. An area enclosed by the demarcation lines L2 and L2b is included in the area A3 and the hysteresis area H2 at the same time. Incidentally, the area A1, the hysteresis area H1, the area A2, the hysteresis area H2 and the area 3 may also be considered as areas which do not overlap each other.

Descriptions will be provided for operations of the operating mode selector 4 for selecting one of the operating modes while the foregoing hysteresis areas H1 and H2 are taken into consideration. For a simpler explanation, an arbitrary end point present in the area A1 but out of the hysteresis area H1 (between the axis of ordinate and the demarcation line L1a) is defined as an end point p1. An arbitrary end point present in the area A1 and in the hysteresis area H1 (between the demarcation lines L1a and L1) is defined as an end point p2. An arbitrary end point present in the area A2 and in the hysteresis area H1 (between the demarcation lines L1 and L1b) is defined as an end point p3. An arbitrary end point present in the area A2 but out of the hysteresis areas H1 and H2 (between the demarcation lines L1b and L2a) is defined as an end point p4. An arbitrary end point present in the area A2 and in the hysteresis area H2 (between the demarcation lines L2a and L2) is defined as an end point p5. An arbitrary end point present in the area A3 and in the hysteresis area H2 (between the demarcation lines L2 and L2b) is defined as an end point p6. An arbitrary end point present in the area A3 but out of the hysteresis area H2 (between the demarcation line L2b and the axis of abscissa) is defined as an end point p7.

It is supposed that the straight movement mode is currently selected by the operating mode selector 4. In a case where an end point of the detected applied operating force vector is any one of the end points p1 and p2 while the straight movement mode is being selected, it is determined that the applied operating force corresponding to the applied operating force vector belongs to the area A1. Thus, the operating mode selector 4 keeps the operating mode to be selected at the straight movement mode.

In addition, in a case where an end point of the detected applied operating force vector is any one of the end points p4 and p5, it is determined that the applied operating force corresponding to the applied operating force vector belongs to the area A2. Thus, the operating mode selector 4 switches the operating mode to be selected from the straight movement mode to the course change mode. However, in a case where an end point of the detected applied operating force vector is the end point p3 while the operating mode is the straight movement mode, the applied operating force corresponding to the applied operating force vector is regarded (treated) as belonging to the area A1 associated with the straight movement mode. As a result, the operating mode is kept at the straight movement mode.

Even if an operator tries to keep the operating mode at the straight movement mode, there are cases where the applied operating force may be slightly off the area A1 associated with the straight movement mode due to shaky application of the operating force or the like. However, as mentioned above, if the applied operating force (the applied operating force vector) whose end point is present in the hysteresis area H1, is treated as belonging to the area A1, the straight movement mode is kept. In other words, unless the end point of the applied operating force vector goes beyond the hysteresis area H1, the operating mode is not switched. Accordingly, this inhibits the operating mode from being unintentionally switched.

Note that it is determined that the applied operating force corresponding to the applied operating force vector belongs to the area A3 in a case where the end point of a detected applied operating force vector is the end point p7 while the operating mode is the straight movement mode. Accordingly, the operating mode selector 4 switches the operating mode to be selected from the straight movement mode to the revolution mode. In addition, where the end point of the detected applied operating force vector is the end point p6 while the operating mode is the straight movement mode, it may be determined that the applied operating force corresponding to the applied operating force vector belongs to the area A2 associated with the course change mode (or the applied operating force corresponding to the applied operating force vector may be regarded as belonging to the area A2 associated with the course change mode). Otherwise, it may be determined that the applied operating force belongs to the area A3. In the case where it is determined that the applied operating force belongs to the area A2 (or in the case where the applied operating force is regarded as belonging to the area A2), the operating mode is switched from the straight movement mode to the course change mode. In the case where it is determined that the applied operating force belongs to the area A3, the operating mode is switched from the straight movement mode to the revolution mode.

Next, the state where the course change mode is selected by the operating mode selector 4 is considered to be a starting point of operation. In a case where the endpoint of the applied operating force vector is any one of the end points p3, p4 and p5, it is determined that the applied operating force corresponding to the applied operating force vector belongs to the area A2. Accordingly, the operating mode selector 4 keeps the operating mode to be selected at the course change mode.

In addition, in a case where the endpoint of the detected applied operating force vector is the end point p1, it is determined that the applied operating force corresponding to the applied operating force vector belongs to the area A1. Accordingly, the operating mode selector 4 switches the operating mode to be selected from the course change mode to the straight movement mode. In a case where the end point of the detected applied operating force vector is the end point p7, it is determined that the applied operating mode corresponding to the vector representing the applied operating mode belongs to the area A3. Accordingly, the operating mode selector 4 switches the operating mode to be selected from the course change mode to the revolution mode.

In a case where, however, the end point of the detected applied operating force vector is any one of the end points p2 and p6 while the operating mode is the change course mode, the applied operating force corresponding to the applied operating force vector is regarded (treated) as belonging to the area A2 associated with the course change mode. In other words, unless the end point of the applied operating force vector goes beyond the hysteresis area H1 or the hysteresis area H2, the operating mode selector 4 does not switch the operating modes. As a result, the operating mode is kept at the course change mode. Accordingly, this inhibits the operating mode from being unintentionally switched due to shaky application of the applied operating force or the like.

The foregoing descriptions have been provided for the methods of switching operating modes which are carried out respectively while the starting point is the straight movement mode or the course change mode. It should be noted that a method of switching operating modes while the starting point is at another mode (for example, the revolution mode) is similarly carried out.

Furthermore, it does not matter that the operating mode may be designed to be immediately switched from the straight movement mode to the course change mode in a case where an applied operating force subsequently detected is determined to belong to the area A2 (or regarded as belonging to the area A2). Otherwise, it does not matter that it is determined whether the operating mode should be switched after comprehensively considering the applied operating forces detected several times.

Applied operating forces are sequentially detected at sampling intervals of a number equivalent to an inverse number of the sampling period. For this reason, in a case where, for example, the applied operating forces, determined to belong to the area A2 (or regarded as belonging to the area A2), are consecutively detected, the operating mode may be designed to be switched from the straight movement mode to the course change mode.

For example, after the applied operating force vector, whose end point is any one of the end points p1, p2 and p3, is detected at a given time, if applied operating forces, determined to belong to the area A2 (or regarded as belonging to the area A2), are detected five consecutive times, the operating mode is switched from the straight movement mode to the course change mode. Conversely, in a case where applied operating forces, determined to belong to the area A2 (or regarded as belonging to the area A2), are detected four consecutive times or less, the operating mode is kept at the straight movement mode. It should be noted that this method may be applied to not only switching from the straight movement mode to the course change mode, but also switching between any two operating modes. In addition, time needed for switching the operating modes (in the foregoing example, time needed for carrying out sampling five times) may be changed whenever necessary.

In other words, while a first operating mode (for example, the straight movement mode) is being selected as the operating mode, if applied operating forces (the applied operating force vectors), determined to belong to an area corresponding to a second operating mode (for example, the course change mode) different from the first operating mode, are consecutively detected for a predetermined period of time, the operating mode selector 4 may be designed to switch the operating mode from the first operating mode to the second operating mode. Accordingly, this further inhibits the operating mode from being unintentionally switched due to shaky application of the operating force to the operating handle 2a or the like, and thus improves the operability further.

Moreover, the operating mode selector 4 may be designed to select an operating mode associated with an area to which the largest number of the applied operating forces, out of a plurality of the applied operating forces detected for a predetermined period of time, are determined to belong (or regarded as belonging). Accordingly, this also inhibits operating modes from being unintentionally switched due to shaky application of an operating force to the operating handle 2a or the like, and thus improves the operability further.

Specific examples of these methods will be cited below. It is supposed that an applied operating force, determined to belong to an area 2 (or regarded as belonging to an area 2), is detected at a subsequent sampling time T1 after the applied operating force vector, whose end point is any one of the end points p1, p2 and p3, is detected while in the straight movement mode. In addition, it is supposed that the applied operating forces, determined to belong respectively to areas A2, A1, A2 and A2 (or regarded as belonging respectively to areas A2, A1, A2 and A2), are sequentially detected at subsequent sampling intervals. In this case, it is determined that the five applied operating forces, detected at the sampling intervals starting at the sampling time T1 (including the applied operating force detected at the sampling time T1), belong respectively to the areas A2, A2, A1, A2 and A2 (or the five applied operating forces are regarded as belonging to the areas A2, A2, A1, A2 and A2).

A2 is an area to which the largest number of the applied operating forces, out of the aforementioned five applied operating forces, are determined to belong (or regarded as belonging). As a result, at a time the last one of the aforementioned five applied operating forces is detected, the operating mode selector 4 switches the operating mode from the straight movement mode to the course change mode (the operating mode selector 4 keeps the straight movement mode before switching the operating mode from the straight movement mode to the course change mode). It should be noted that this scheme may be applied to not only switching from the straight movement mode to the course change mode, but also switching between any two operating modes. In addition, time needed for switching operating modes (in the foregoing example, time needed for carrying out sampling five times) may be changed whenever necessary.

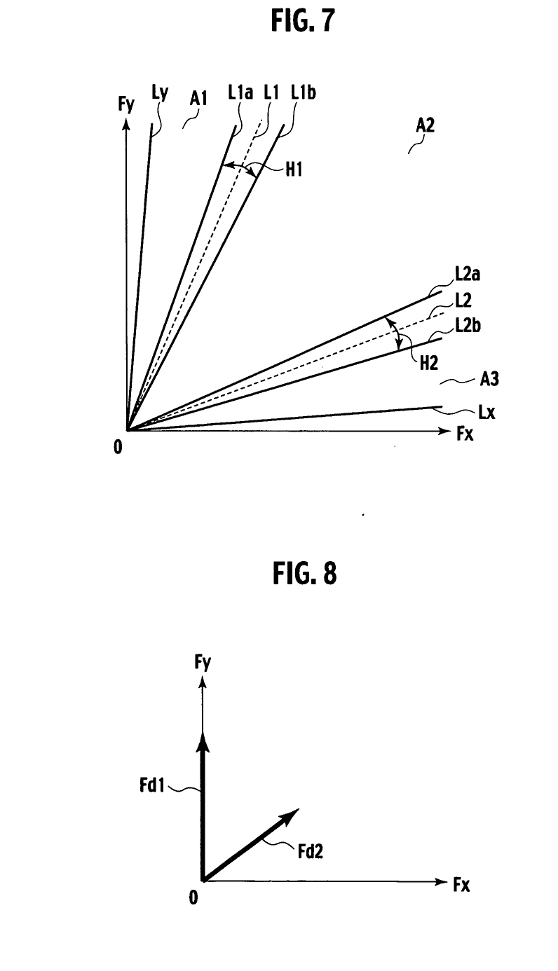

Moreover, it does not matter that, as shown in FIG. 7, a demarcation line Ly is set up between the demarcation line L1a and the axis of ordinate. An area between the demarcation line Ly and a demarcation line (not illustrated) set up in an area in the second quadrant (not illustrated) abutting on the area A1 constitutes a hysteresis area set up between the area A1 and the area in the second quadrant. Incidentally, in a case where an operating mode associated with the area in the second quadrant is the straight movement mode which is the same as the operating mode associated with the area A1, the demarcation line Ly may be omitted.

Similarly, it does not matter that a demarcation line Lx is set up between the demarcation line L2b and the axis of abscissa. An area between the demarcation line Lx and a demarcation line (not illustrated) set up in an area in the fourth quadrant (not illustrated) abutting on the area A3 constitutes a hysteresis area set up between the area A3 and the area in the fourth quadrant. However, in a case where the operating mode associated with the area in the fourth quadrant is the revolution mode which is the same as the operating forces associated with the area A3, the demarcation line Ly may be omitted. Incidentally, in FIG. 7, the same reference numerals are used to designate the same items as those in FIG. 6

(Restriction on Change in a Driving Force)

Following operations are performed when operating modes are switched. It is supposed that the selected mode is currently the straight movement mode. At this time, it is supposed that the driving wheels constituted of the right rear wheel 1a and the left rear wheel 1b are driven by the right rear wheel motor 8a and the left rear wheel motor 8b, and thereby revolve at the same rotation speed in the same rotation direction. In addition, it is supposed that the driving force in the Y-axis direction is accordingly imparted to the carriage 1. A vector representing this driving force is defined as a driving force vector Fd1. The driving force vector Fd1 is shown in FIG. 8. FIG. 8 is a vector diagram showing the first quadrant in which the driving force vector appears. In FIG. 8, the axis of abscissa indicates the X-axis component (Fx) of the force, and the axis of ordinate indicates the Y-axis component (Fy) of the force, as in FIG. 5. As described above, the driving force vector Fd1 corresponds to the straight movement mode. For this reason, the direction of the driving force vector Fd1 is equal to the Y-axis direction (the Fy-axis direction).

It is supposed that the operating mode is subsequently switched from the straight movement mode to the course change mode by the first switching method described above. By this switching, the driving force represented by the driving force vector Fd2 is finally imparted to the carriage 1, and the desired course change is performed. Unlike the driving force vector Fd1, the driving force vector Fd2 has the X-axis component (the X-axis component is not equal to zero).

When the switching of the operating modes is conveyed from the operating mode selector 4 to the operation control signal outputting unit 5, the operation control signal outputting unit 5 outputs necessary control signals in order that the strength of the driving force applied to the carriage 1 is finally changed from |Fd1| to |Fd2|, and in order that the direction in which the driving force works is finally changed from the direction of the driving force vector Fd1 to the direction of the driving force vector Fd2. In this respect, |Fd1| represents the magnitude of the driving force vector Fd1, and is equal to the square root of the sum of the square of the X-axis component of the Fd1 and the square of the Y-axis component of Fd1. |Fd2| represents the magnitude of the driving force vector Fd2, and is equal to the square root of the sum of the square of the X-axis component of the Fd2 and the square of the Y-axis component of Fd2.

The operating modes cannot be smoothly switched, if the strength of the driving force is instantaneously changed from |Fd1| to |Fd2| during the switching of the operating modes. Against this background, when the switching of the operating modes is conveyed from the operating mode selector 4 to the operation control signal outputting unit 5, the operation control signal outputting unit 5 outputs control signals needed for the switching of the operating modes while holding the rate of change per unit time of strength of the driving force imparted to the carriage 1 at or under a first upper limit value (or while imposing an upper limit on the rate of change per unit time). This is equivalent to gradual change of the strength of the driving force, which takes a certain length of time.

In addition, if the direction in which the driving force works is instantaneously changed from the direction of the driving force vector Fd1 to the driving force vector Fd2 during the switching of the operating modes, this instantaneous change also hinders a smooth change of the operating mode. Against this background, when the switching of the operating modes is conveyed from the operating mode selector 4 to the operation control signal outputting unit 5, the operation control signal outputting unit 5 outputs control signals needed for the switching of the operating modes while holding the rate of change per unit time of the direction in which the driving force imparted to the carriage 1 works at or under a predetermined second upper limit value (or while imposing an upper limit on the rate of change per unit time). This is equivalent to gradual change of the direction in which the driving force works, which takes a certain length of time.

Furthermore, if the speed at which the carriage 1 moves suddenly changes in response to an instantaneous change of the strength of the driving force, the operator feels a sense of incompatibility. Against this background, when the switching of the operating modes is conveyed from the operating mode selector 4 to the operation control signal outputting unit 5, the operation control signal outputting unit 5 outputs control signals needed for the switching of the operating modes while holding the rate of change per unit time of the speed at which the carriage 1 moves (operates) at or under a predetermined third upper limit value (or while imposing an upper limit on the rate of change per unit time). This is equivalent to gradual change of the speed at which the carriage 1 moves, which takes a certain length of time.

Moreover, if the direction in which the carriage 1 moves suddenly changes in response to an instantaneous change of the direction in which the driving force works, the operator feels a sense of incompatibility. Against this background, when the switching of the operating modes is conveyed from the operating mode selector 4 to the operating control signal outputting unit 5, the operating control signal outputting unit 5 outputs control signals needed for the switch of the operating modes while holding the rate of change per unit time of the direction in which the carriage 1 moves (operates) at or under a predetermined fourth upper limit (or while imposing an upper limit on the rate of change per unit time). This is equivalent to gradual change of the direction in which the carriage 1 moves, which takes a certain length of time.

In a case where attention is paid to the driving force imparted to each of the right rear wheel 1a and the left rear wheel 1b which are the driving wheels, if the strength of the driving force suddenly changes, the operating mode is hindered from being switched smoothly. Against this background, when the switching of the operating modes is conveyed from the operating mode selector 4 to the operation control signal outputting unit 5, the operation control signal outputting unit 5 may be designed to output control signals needed for the switching of the operating modes while holding the rate of change per unit time of the strength of the driving force imparted to each of the right rear wheel 1a and the left rear wheel 1b at or under a predetermined fifth upper limit (or while imposing an upper limit on each rate of change per unit time). This is equivalent to gradual change of the strength of the driving force imparted to each of the right rear wheel 1a and the left rear wheel 1b, which takes a certain length of time.

As noted above, the gradual change of the strength of the driving force and of the direction at which the driving force works enables the operating modes to be switched smoothly without causing the operator to feel the sense of incompatibility.

Moreover, the installation of the three pressure sensors 3a, 3b and 3c makes it possible to detect not only the X-axis component and the Y-axis component of the applied driving force but also the rotation moment about the Z axis (not illustrated) as described above. When forces detected by the pressure sensors 3b and 3c are defined as Fiy1 and Fiy2, the operation control signal outputting unit 5 calculates the rotation moment about the Z axis on the basis of the difference between Fiy1 and Fiy2. In addition, the operation signal outputting unit 5 calculates a rotation speed and direction of each of the right rear wheel 1a and the left rear wheel 1b, which correspond to a reverse rotation moment offsetting the calculated rotation moment about the Z axis. While in each operating mode (each of the straight movement mode, the course change mode and the revolution mode), the operating signal control outputting unit 5 calculates the rotation speed and the rotation direction, which each of the right rear wheel 1a and the left rear wheel 1b needs to follow in the operating mode, while assessing the rotation speed and rotation direction of each of the right rear wheel 1a and the left rear wheel 1b, which correspond to the reverse rotation moment. Thus, the operation control signal outputting unit 5 outputs adequate control signals (motor instruction values). As a result, the rotation moment generated by the operation of the operator is offset, and the carriage 1 accordingly performs an accurate straight movement, course change movement or revolution movement.

In addition, a movement speed of the carriage 1 while in the straight movement mode, a movement speed in the circumferential direction and a rotational angular speed about the axis of rotation of the carriage 1 while in the course change mode, and a rotational angular speed of the carriage 1 while in the revolution mode, may be changed on the basis of the strength of the applied operating force and the direction in which the applied operating force works, whenever necessary. For example, it suffices that the movement speed of the carriage 1 while in the straight movement mode is proportioned to the size of the Y-axis component of the applied operating force.

An example has been shown above where the driving wheels (the right rear wheel 1a and the left rear wheel 1b) are fixed to the housing of the carriage. However, the present invention is not limited to this example. In other words, it does not matter that, like the right front wheel 1c and the left front wheel 1d, the driving wheels are pivotably attached to the housing of the carriage. In this case, the carriage changes its course, or revolves, by additional use of rotation of each of the driving wheels about a vertical line passing through the center of the driving wheel.

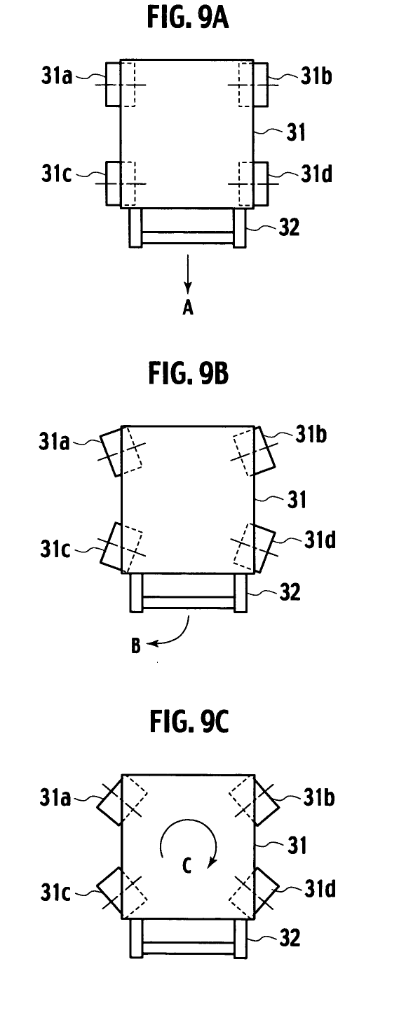

FIGS. 9A, 9B and 9C are plan views of a carriage 31 having such a configuration. Four wheels, which are a right rear wheel 31a, a left rear wheel 31b, a right front wheel 31c and a left front wheel 31d, are attached to the carriage 31. All of the four wheels are driving wheels. Each of the four wheels is pivotably attached to the housing of the carriage 31. In addition, a power assist apparatus 32 is attached to the carriage 31. The power assist apparatus 32 controls a rotation speed, a rotation direction and a direction of each of the wheels 31a, 31b, 31c and 31d depending on an operating force applied to the power assist apparatus 32, whereas the power assist apparatus 2 controls a rotation speed and the rotation direction of each of the right rear wheel 1a and the left rear wheel 1b depending on an operating force applied to the power assist apparatus 2. Except for this difference in the control of the wheels, the power assist apparatus 32 is configured and operated in the same manner as the power assist apparatus 2 is configured and operated.

FIG. 9A shows a direction of each of the wheels while in the straight movement mode. FIG. 9B shows a direction of each of the wheels while in the course change mode. FIG. 9C shows a direction of each of the wheels while in the revolution mode. In FIG. 9A, all of the right rear wheel 31a, the left rear wheel 31b, the right front wheel 31c and the left front wheel 31d face in a direction which causes the carriage to move straight to the front, and are in a state of causing the carriage to move straight to the front in a direction shown by an arrow A. In FIG. 9B, the right front wheel 31c and the left front wheel 31d face in a direction which causes the carriage to change its course in a direction shown by an arrow B, whereas the right rear wheel 31a and the left rear wheel 31b face in a direction opposite to the direction shown by the arrow B. Thus, the wheels are in a state of causing the carriage to change its course in the direction shown by the arrow B. In FIG. 9C, the sides respectively of the right front wheel 31c and the left front wheel 31d near the power assist apparatus 32 face toward the inside, whereas the sides respectively of the right rear wheel 31a and the left rear wheel 31b near the power assist apparatus 32 face toward the outside. Thus, the wheels are in a state of causing the carriage to revolve in a direction shown by an arrow C.

Furthermore, it suffices that an upper limit is imposed on a rotational angular speed of rotation of each of the wheels (31a, 31b, 31c and 31d) about its vertical line passing through the center of the wheel. The direction in which the driving force imparted to the carriage 31 work is specified by the directions respectively of the wheels relative to the housing of the carriage 31. As a result, the imposition of the upper limit in the aforementioned manner is equivalent to imposition of an upper limit on the rate of change per unit time of the direction in which the driving force imparted to the carriage 31 works. The operation control signal outputting unit (not illustrated) included in the power assist apparatus 32 outputs control signals needed for the switching of the operating modes while complying with the upper limit, and thus changes the direction of each of the wheels adequately.

(Other Example)

It should be noted that the determination area information is stored, as predetermined information, in the area information storage unit 6. With the determination area information, the demarcation lines L1 and L2 as shown in FIG. 5 and the like are set up. However, it does not matter that these demarcation lines L1 and L2 are capable of being changed depending on an applied operating force applied by an operator to the power assist apparatus and the like. For example, it does not matter that the crossing angle between the demarcation line L1 and the axis of abscissa (the Fx axis) is made smaller, or larger, than that shown in FIG. 5 depending on the applied operating force actually applied by the operator with the intention of selecting the straight movement mode. Moreover, in a case where the crossing angle between the demarcation line L1 and the axis of abscissa and the crossing angle between the demarcation line L2 and the axis of abscissa are changed, the crossing angle between the axis of abscissa and each of the demarcation lines L1a, L1b, L2a and L2b are also changed in conjunction.

The above example has been provided where the power assist apparatus 2 is applied to the carriage (the aforementioned carriage 1 and the like). However, the power assist apparatus 2 is applicable to various movable bodies. Examples of movable bodies to which the power assist apparatus 2 is applicable include wheeled chairs (electrically-driven wheeled chairs) in addition to carriages. The wheeled chairs are used for helping operators with walking disability move easily.

Furthermore, the present invention is applicable to not only the configuration for controlling the rotation speed of each wheel (each of the right rear wheel 1a and the left rear wheel 1b in FIG. 2, as well as the right rear wheel 31a and the like in FIG. 9) depending on an applied operating force, but also a configuration for controlling a torque applied to each wheel (a torque imparted to each wheel for the purpose of driving the wheel to rotate) depending on the applied operating force.

The power assist apparatus according to the present invention is suitable for movable bodies including carriages (wheeled dollies) and wheeled chairs (electrically-driven wheeled chairs). In addition, the power assist apparatus according to the present invention is applicable (or may be installed) to various objects of operation whose operations are controlled respectively depending on operating forces applied to the objects of operation. The power assist apparatus according to the present invention is suitable, for example, for robot arms, and power-assisted robots, which perform various types of work (for example, transfer a heavy load).

As described above, in the case of the power assist apparatus according to the present embodiments and the movable body including the power assist apparatus, operating modes are inhibited from being unintentionally switched due to shaky application of an operating force or the like.

The present invention includes other embodiments which do not depart from the spirit or essential characteristics thereof in addition to what has been described with regard to these embodiments. These embodiments have been disclosed for the illustrative purpose, but not for the purpose of imposing a restriction on the scope of the invention. The scope of the invention shall be shown by the scope of claims, but not by the description in the specification. Consequently, the present invention shall be interpreted as covering all of the embodiments including meanings and scopes within the range of equivalency of the claims.

What is claimed is:

1. A power assist apparatus with a plurality of operating modes, which causes an object of operation to operate in one of the operating modes depending on an operating force applied thereto, the power assist apparatus comprising:
an operation unit to which the operating force is applied;
an applied operating force detector configured to detect an applied operating force applied to the operation unit;
an operating mode selector configured to determine to what area out of a plurality of areas the applied operating force detected belongs, and to select an operating mode associated with the area determined, the plurality of areas being demarcated based on directions in which the applied operating force works, and being associated with the plurality of operating modes; and
an operation control signal outputting unit configured to output an operation control signal for controlling an operation of the object of operation depending on the operating mode thus selected,
wherein a hysteresis area is set up between each two adjacent areas of the plurality of areas, and
wherein, while in a first operating mode in which the operating mode to be selected is included in the plurality of operating modes, the operating mode selector selects the first operating mode when the applied operating force thus detected belongs to a hystereis area abutting on an area associated with the first operating mode.

2. The power assist apparatus as claimed in claim 1, wherein the plurality of areas are demarcated based on strengths of forces and on directions in which the forces work.

3. The power assist apparatus as claimed in claim 2, wherein the operating mode selector determines to what area the applied operating force belongs based on a strength of the applied operating force thus detected, and on a direction in which the applied operating force thus detected works.

4. The power assist apparatus as claimed in claim 1, wherein, while the first operating mode is being selected, in a case where, based on the applied operating force, it is consecutively detected for a predetermined period of time that the applied operating force belongs to an area associated with a second operating mode different from the first operating mode, the operating mode selector selects the second operating mode.

5. The power assist apparatus as claimed in claim 1, wherein the applied operating force detector detects applied operating forces, which are applied to the operating unit, at predetermined sampling intervals, and
wherein, while the first operating mode is being selected, in a case where, based on the applied operating forces, it is consecutively detected predetermined times that the applied operating forces belong to an area associated with a second operating force different from the first operating mode, the operating mode selector selects the second operating mode.

6. The power assist apparatus as claimed in claim 1, wherein, by detecting an applied operating force in a first direction, and an applied operating force in a second direction perpendicular to the first direction, which are applied to the operation unit, the applied operating force detector detects an applied operating force vector in the first direction and an applied operating force vector in the second direction.

7. The power assist apparatus as claimed in claim 6, wherein the operating mode selector determines to what area the applied operating force thus detected belongs based on the applied operating force vector in the first direction and the applied operating force vector in the second direction.

8. The power assist apparatus as claimed in claim 1, wherein, when the operating mode selected by the operating mode selector is switched to another operating mode, the operation control signal outputting unit outputs an operation control signal needed for the switching of the operation modes while imposing an upper limit on a rate of change per unit time of strength of a driving force for causing the object of operation to operate.

9. The power assist apparatus as claimed in claim 1, wherein, when the operating mode selected by the operating mode selector is switched to another operating mode, the operation control signal outputting unit outputs an operation control signal needed for the switching of the operation modes while imposing an upper limit on a rate of change per unit time of a direction in which a driving force for causing the object of operation to operate works.

10. A movable body including a power assist apparatus, comprising:
an object of operation which moves;
a driving unit which is included in the object of operation, and which causes the object of operation to operate based on an operation control signal outputted from an operation control signal outputting unit; and
a power assist apparatus with a plurality of operating modes, which causes the object of operation to operate in one of the operating modes depending on an operating force applied,
wherein the power assist apparatus comprises:
an operation unit to which the operating force is applied;
an applied operating force detector configured to detect an applied operating force applied to the operation unit;
an operating mode selector configured to determine to what area out of a plurality of areas the applied operating force thus detected belongs, and for selecting an operating mode associated with the area thus determined, the plurality of areas being demarcated based on directions in which the applied operating force works, and being associated with the plurality of operating modes; and
the operation control signal outputting unit configured to output the operation control signal for controlling an operation of the object of operation depending on the operating mode thus selected,
wherein a hysteresis area is set up between each two adjacent areas of the plurality of areas, and
wherein, while in a first operating mode in which the operating mode to be selected is included in the plurality of operating modes, the operating mode selector selects the first operating mode when the applied operating force thus detected belongs to a hysteresis area abutting on an area associated with the first operating mode.

11. The power assist apparatus as claimed in claim 10, wherein the operation unit comprises:
an operating handle; and
handle supporting parts for fixing the operating handle and the object of the operation with each other.

12. The movable body as claimed in claim 11, wherein the applied operating force detector comprises:
a first pressure sensor which is provided to the operating handle, and which detects an applied operating force in a first direction applied to the operating handle; and
a second pressure sensor which is provided to one of the handle supporting parts, and which detects an applied operating force in a second direction perpendicular to the first direction, the applied operating force being applied to the operating handle.

13. The movable body as claimed in claim 11, wherein second sensors are provided to a plurality of locations of the handle supporting parts, and thus detect a rotation moment in a third direction perpendicular to the first and second directions.

14. The movable body as claimed in claim 12, wherein, by means of the first pressure sensor and the second pressure sensor, an applied operating force vector in the first direction and an applied operating force vector in the second direction are detected from the applied operating force.

15. The movable body as claimed in claim 14, wherein the operating mode selector determines to what area the applied operating force thus detected belongs based on the applied operating force vector in the first direction and the applied operating force vector in the second direction.

16. The movable body as claimed in claim 10, wherein, while the first operating mode is being selected, in a case where, based on the applied operating force, it is consecutively detected for a predetermined period of time that the applied operating force belongs to an area associated with a second operating mode different from the first operating mode, the operating mode selector selects the second operating mode.

17. The movable body as claimed in claim 10,
wherein the applied operating force detector detects applied operating forces, which are applied to the operating unit, at predetermined sampling intervals, and
wherein, while the first operating mode is being selected, in a case where, based on the applied operating forces, it is consecutively detected predetermined times that the applied operating forces belong to an area associated with a second operating force different from the first operating mode, the operating mode selector selects the second operating mode.

18. The movable body as claimed in claim 10, wherein, when the operating mode selected by the operating mode selector is switched to another operating mode, the operation control signal outputting unit outputs an operation control signal needed for the switching of the operation modes while imposing an upper limit on a rate of change per unit time of strength of a driving force for causing the object of operation to operate.

19. The movable body as claimed in claim 10, wherein, when the operating mode selected by the operating mode selector is switched to another operating mode, the operation control signal outputting unit outputs an operation control signal needed for the switching of the operation modes while imposing an upper limit on a rate of change per unit time of a direction in which a driving force for causing the object of operation to operate works.
